(19) United States
(12) Patent Application Publication
(10) Pub. No.: US 2014/0355043 A1
(43) Pub. Date: Dec. 4, 2014

(54) PRINT PRODUCTION MANAGEMENT

(71) Applicant: Hewlett-Packard Development Company, L.P., Houston, TX (US)

(72) Inventors: Jun Zeng, Palo Alto, CA (US); Qing Duan, Durham, NC (US); Gary J. Dispoto, Palo Alto, CA (US)

(21) Appl. No.: 13/908,375

(22) Filed: Jun. 3, 2013

(51) Int. Cl. G06F 3/12

(52) U.S. Cl. CPC G06F 3/1259
USPC 358/1.15

(57) ABSTRACT

Printing production management is performed by accessing a production event log that includes entries that correspond to different stages of a plurality of pending print orders. In response to receiving an inquiry for a time for completing process steps of a print job, a current status of the pending print orders is accessed from the production event log. A predictive model for the print job is generated based on completion times for the process steps of the print job accessed from the production event log. A time for completing the process steps of the print job is predicted based on the predictive model and the current status of the pending print orders.

### BACKGROUND

Commercial printers produce magazines, phone books, labels, advertising brochures, catalogs, newspaper inserts, direct mail marketing pieces, corporate reports and other financial printing, training manuals, promotional materials, and business forms. Most commercial printers offer four distinct services: design and other prepress services; actual printing; finishing (including folding, cutting, and binding); and post press processes (including packing, storing, and shipping). A commercial printer may have different computers, software, presses, binding equipment and workers available to work on various types of jobs.

### BRIEF DESCRIPTION OF THE DRAWINGS

The following detailed description references the drawings, wherein:

FIG. 1 is a block diagram of an example server computing device in communication via a network with a client computing device for managing print production;

FIG. 2 is an example of a production event log;

FIG. 3 is another example of a production event log;

FIG. 4 is a flowchart of an example method for execution by a client computing device and a server computing device for managing print production;

FIG. 5 is a flowchart of an example method for execution by a client computing device and a server computing device for managing print production; and

FIG. 6 is a flowchart of an example method for execution by a server computing device for generating a regression model.

FIG. 7 is a flowchart of an example method for execution by a server computing device for generating an error probability density function;

FIG. 8 is a flowchart of an example method for execution by a server computing device for predicting a lead time of process steps of a print job; and

FIG. 9 is an example of a predicted value probability density function for a lead time of process steps of a print job.

### DETAILED DESCRIPTION

A print service provider's ability to accurately forecast production in real-time is key to the commercial value-creation chain. Print service providers commonly rely on human observation to provide such forecasting. However, this approach exposes print service providers to high margins of error and inconsistency, and is not scalable to handle high volume production.

Example automated processes disclosed herein address these issues by providing commercial printing workflow management to track printing production events. Production event logs are used to record production events of individual print jobs while process steps of the print jobs are completed. The production events that are recorded may include a time at which a process step arrives at a printing resource for execution, an amount of time between arrival and a start time of process step execution at the printing resource, and a time at which the process step is completed at the printing resource. Production event logs may also record events that may not directly link with the production process, for example, events that monitor the health of printing equipment. The production event logs are subsequently mined to provide forecasting capabilities to aid print production management, and to provide predictive modeling capabilities for print service providers.

Print production forecasting may occur at multiple scopes, for example, at a factory level (e.g., at a storefront where a customer service representative accepts orders), at a work-cell level (e.g., at the starting point of a production line), and at a machine level (e.g., at the control panel of a printing press). A customer service representative may need to predict if a printing request with a short delivery window is serviceable given current workload and to identify appropriate priority and pricing. A foreman may need to predict the depletion of a job backlog for a work cell by an end of a shift. A pressman may need to predict which printing jobs will be fulfilled before a scheduled break or maintenance. Print service providers may rely on such forecasting in real-time to maximize the deployment of their production resources and ensure on-time service delivery.

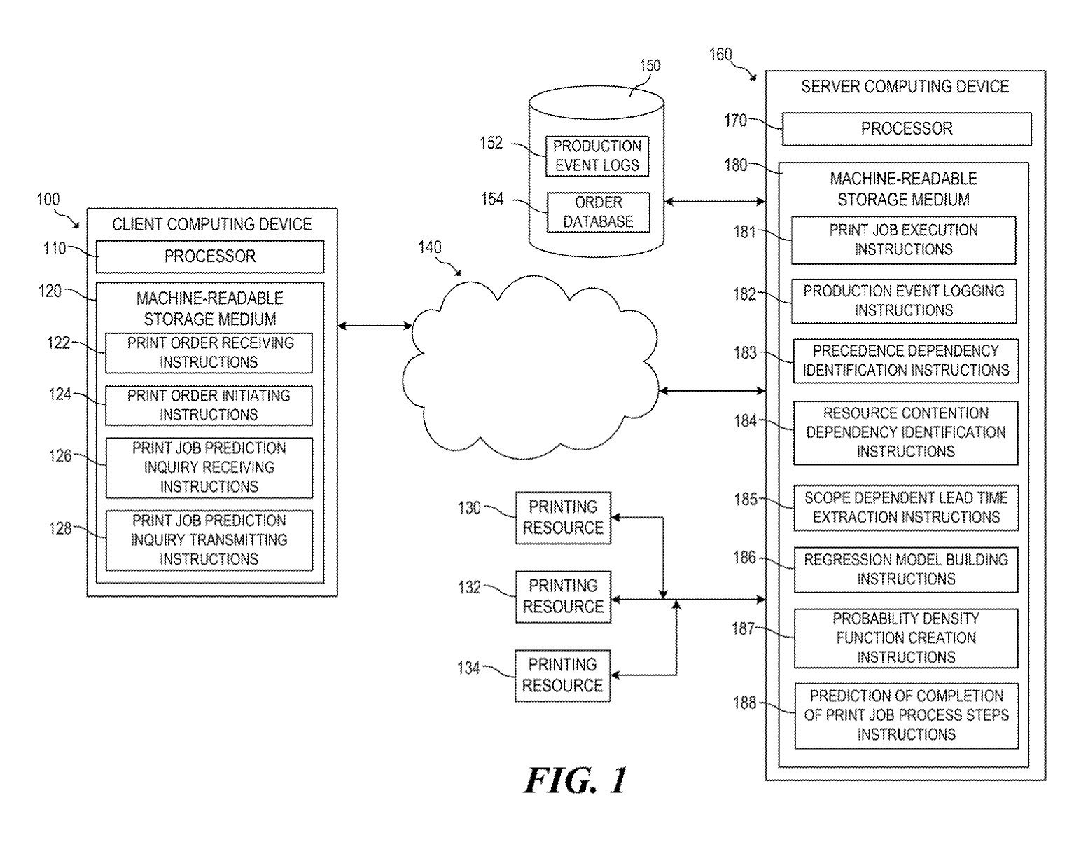

Referring now to the drawings, FIG. 1 is a block diagram of an example server computing device 160 in communication via a network 140 with a client computing device 100. A storage device 150 may also be provided such that server computing device 160 may access storage device 150. Printing resources 130, 132, 134 may also communicate with server computing device 160. In some embodiments, storage device 150 and printing resources 130, 132, 134 may be coupled to network 140. Printing resources 130, 132, 134 may include computer software, printing presses, finishing services and workers on the printing production floor. Printing resources 130, 132, 134 may provide data to or receive data from client computing device 100, server computing device 160 and storage device 150. As illustrated in FIG. 1 and described below, server computing device 160 may communicate with client computing device 100, storage device 150, and printing resources 130, 132, 134 to manage print production.

Server computing device 160 may be any computing device accessible to a client device, such as client computing device 100, over network 140. Example networks include the Internet, a local area network (LAN), and a wide area network (WAN). In the embodiment of FIG. 1, server computing device 160 includes a processor 170 and a machine-readable storage medium 180.

Processor 170 may be one or more central processing units (CPUs), microprocessors, and/or other hardware devices suitable for retrieval and execution of instructions stored in machine-readable storage medium 180. Processor 170 may fetch, decode, and execute instructions 181, 182, 183, 184, 185, 186, 187, 188 to manage print production, as described below. As an alternative or in addition to retrieving and executing instructions, processor 170 may include one or more electronic circuits comprising a number of electronic components for performing the functionality of one or more of instructions 181-188.

Machine-readable storage medium 180 may be any electronic, magnetic, optical, or other physical storage device that stores executable instructions. Thus, machine-readable storage medium 180 may be, for example, Random Access Memory (RAM), an Electrically-Erasable Programmable Read-Only Memory (EEPROM), a storage drive, an optical disc, and the like. As described in detail below, machine-readable storage medium 180 may be encoded with executable instructions 181-188 for managing print production.

Client computing device 100 may be, for example, a notebook computer, a desktop computer, an all-in-one system, a thin client, a workstation, a tablet computing device, a mobile phone, or any other computing device suitable for execution of the functionality described below. In FIG. 1, client computing device 100 includes processor 110 and machine-readable storage medium 120.

As with processor 170 of server computing device 160, processor 110 may be one or more CPUs, microprocessors, and/or other hardware devices suitable for retrieval and execution of instructions 122, 124, 126, 128. Processor 110 may fetch, decode, and execute instructions to manage print production. Processor 110 may also or instead include electronic circuitry for performing the functionality of one or more instructions 122, 124, 126, 128. As with storage medium 180 of server computing device 160, machine-readable storage medium 120 may be any physical storage device that stores executable instructions.

Communication may be established between client computing device 100 and server computing device 160. For example, client computing device 100 may access server computing device 160 at a predetermined Uniform Resource Locator (URL) and, in response, server computing device 160 may establish a communication session with client computing device 100. In some implementations, client login credentials, such as a user identifier and a corresponding authentication parameter (e.g., a password), may be used to establish communication with server computing device 160.

Storage device 150 may be any hardware storage device for maintaining data accessible to server computing device 160. For example, storage device 150 may include one or more hard disk drives, solid state drives, tape drives, and/or any other storage devices. Storage device 150 may be located in server computing device 160 and/or in another device in communication with server computing device 160.

Storage device 150 may store production event logs 152 that are used by server computing device 160 for managing print production, as discussed in detail below. Production event logs 152 may be generated by tracking production activities as a print job is fulfilled through print production lines. Example production activities may include downloading an order, planning a product that is part of the order, manufacturing parts (e.g., printing book covers and book blocks that are included in a product), assembling parts into a product, packaging products, shipping, etc. Each production event produces an event trace stored in an event log database. An event trace may include timestamps, a process identifier, an equipment identifier, an employee identifier, an order identifier, products included in an order, and other information, as discussed in detail below.

Storage device 150 may also include an order database. Order database 154 may provide data corresponding to a detailed description of previous orders including order arrival time, expected due time, quantity and type of required products, pricing, and customer information. Order database 154 may also provide data corresponding to a customer's order specifications, for example, color, dimension, finishing, and service level agreements.

Print order receiving instructions 122 may receive a print order to be processed. In one implementation, the print order may be received as user input from a customer service representative. In other implementations, the print order may be received automatically without human involvement through web-to-print services. The print order may identify the specific characteristics of the completed print job that a customer desires such as quantity, printing specifications, finishing requirements, expected due time, etc. Multiple print orders may be received by print order receiving instructions 122. The different production events that occur during execution of print jobs corresponding to the print orders are recorded in production event logs 152, as discussed in detail below.

Print order initiating instructions 124 may cause a received print order to begin execution as a print job. A print job may begin execution by first being transmitted to server computing device 160 via network 140. Print order execution instructions 181 at server computing device 160 may cause the identified process steps for completing the print order to commence. For example, the process steps for completing the print order may be executed at any of printing resources 130, 132, 134.

Production event logging instructions 182 record specific production events that occur while executing individual process steps of a print job. The print job is processed as it flows through different printing resources 130, 132, 134 in the production process that can be either sequential or parallel. When a print job arrives at a resource in the production process, production event logging instructions 182 may record the time at which the print order has arrived at the resource. Other print jobs may be waiting in a queue with a higher priority such that the step cannot be processed immediately. Production event logging instructions 182 may also record a time at which a print job arrives in a queue, a time at which work begins on the print job in the queue, and a time at which work finishes on the print job. Production event logging instructions 182 may also record an identification of the process step that was executed at a particular printing resource 130, 132, 134, an identification of the printing resource 130, 132, 134, and an identification of a worker that is responsible for the process step being completed at the resource. Print order execution instructions 181 may then cause the next process steps for the print job to be initiated and executed until all process steps of the print job are complete. Production event logging instructions 182 continue to record specific production events that occur during execution of the print job.

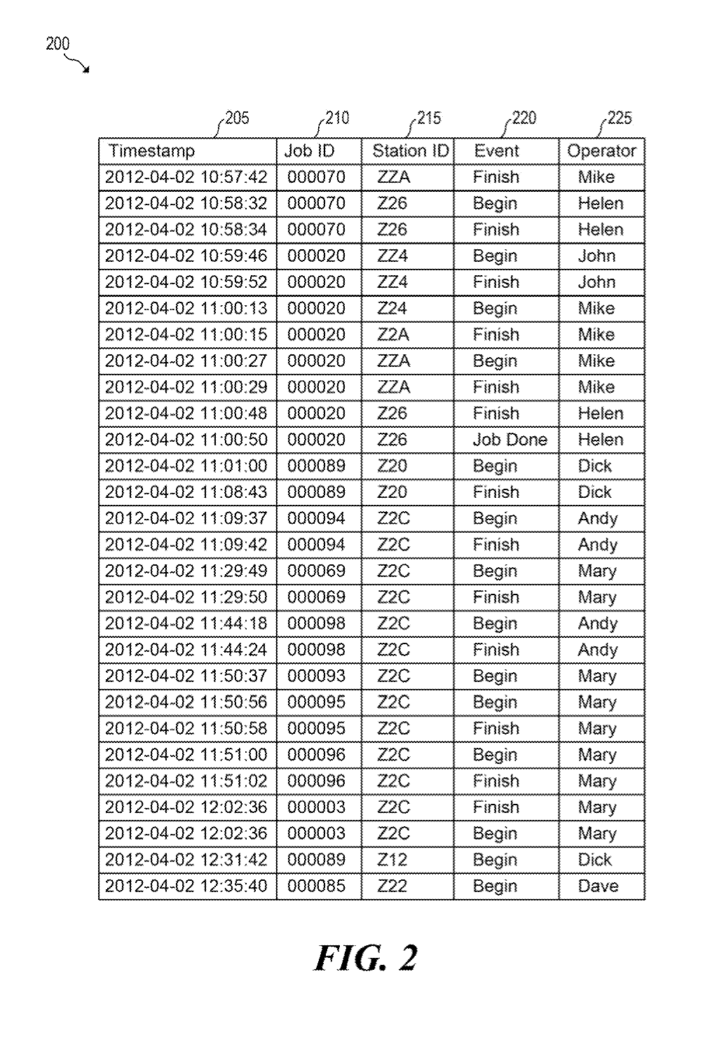

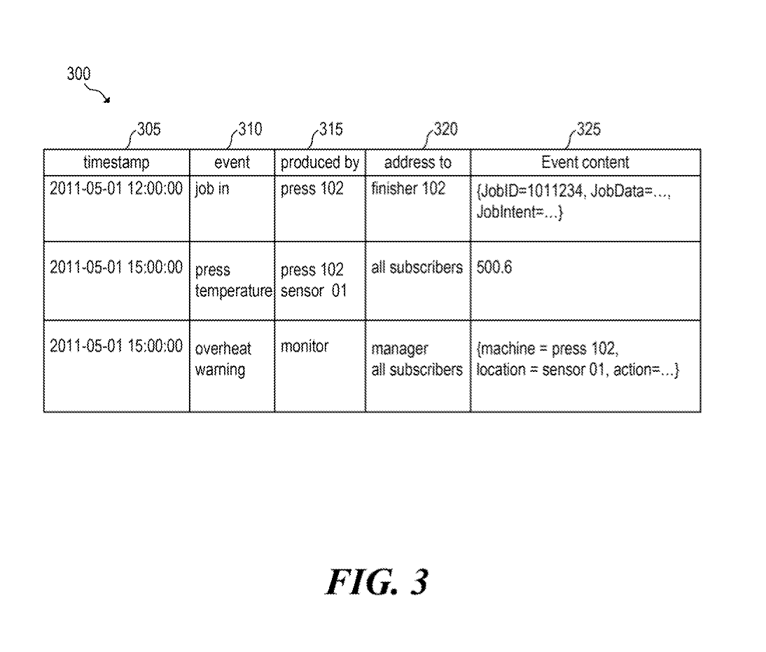

Each entry in a production event log may correspond to one production event. Columns in the production event log may include an identifier for the print job, job content, a job profile, a process identifier, a resource identifier, an employee identifier, a process step, an event, timestamp, etc. For example, as shown in FIG. 2, a production event log 200 includes entries corresponding to a timestamp 205, a print job identifier 210, a resource identifier 215, an event 220, and an operator 225. In another example, as shown in FIG. 3, a production event log 300 includes entries corresponding to a timestamp 305, an event 310, an identification of the resource that produced the event 315, an identification of a resource to which the event is addressed 320, and the content of the event 325. The production event logs may also record events that may not directly link with the production process such as events that monitor the health of the equipment. Examples of such events shown in FIG. 3 include the “press temperature” event and the “overheat warning” event.

In some implementations, a barcode scanner may be used to obtain some aspects of the production event logging. For example, employee identifiers can be acquired by scanning a worker's badge. Identifiers for an order or a product may be acquired by scanning a barcode printed on a job ticket, i.e., a sheet of paper travelling with an order with production instructions.

A printing service provider may fulfill many orders concurrently, each of which requires execution of multiple production steps using a finite set of equipment on the factory floor. The execution of a process step may interact with other process steps in two ways: precedence dependency and resource contention dependency. Precedence dependency refers to a process step of a print job that can begin only after a process step for the same print job has successfully completed. Resource contention dependency refers to multiple jobs sharing the same resource. Process mining techniques are applied on production event logs 152 to discover the precedence dependency among the process steps of the same print job, and the resource contention dependency among different print jobs.

Precedence dependency identification instructions 183 may identify the process steps for the print job that can begin only after a process step for the same job has successfully completed. Precedence dependency identification instructions 183 may mine production event logs 152 to discover the precedence dependency among the process steps. By applying process mining to production event logs, event traces for the print job may be discovered. For each print step in the print job, any print steps that are to be executed first are appended to the print step that is to be executed subsequently.

Resource contention dependency identification instructions 184 may identify multiple pending print jobs that share the same resource. Resource contention dependency identification instructions 184 may mine production event logs 152 to discover the resource contention dependency among different pending print jobs. At any given time and at any machine or work cell, multiple process jobs may be queued while awaiting execution. These process steps may be competing for the same processing resource. Such resource contention dependencies may be discovered by mapping the process steps to resource queues. In one implementation, resource contention dependencies may be predicted by mining production event logs 152 and order database 154 to identify operational rules that a factory uses to determine priority among different types of orders. Production event logs 152 and order database 154 may also be mined to determine which suitable machine should receive a particular job. For each resource queue, a process step in the queue may be appended with higher-priority process steps in the same queue.

Scope dependent lead time extraction instructions 185 may extract a lead time for each print order using timestamps in production event logs 152. Attributes at different scopes of interest are also extracted and indexed. Example attributes may include a print job payload description obtained from order database 154, workflow, and a current factory workload. The current factory workload identifies the status of pending print jobs and pending jobs that are distributed among printing resources. Both the workflow and the current factory workload may be determined based on the precedence dependencies and the resource contention dependencies.

Timestamp differences between process steps may provide lead times at the order level, the product level, the part level and the process step level. For example, a timestamp difference between an order's shipping and admission events provides a lead time at the order level; a timestamp difference between a package and an order serialized provides a lead time at the product level: a timestamp difference between creation of a part and completion of the part awaiting assembly provides a lead time at a part level; and a timestamp difference between completion of one process step and completion of a previous process step provides a lead time at the process step level. The lead times that are extracted for each print order are used to form a training set and a test set. Both the training set and the test set may include known instances which include attributes for making a prediction and an actual lead time. Each instance in the training set may include the attributes of a particular process step and the attributes of the process steps identified through dependency discovery.

Regression model building instructions 186 may build a regression model using the training set of lead times. The training set may include the print order, the lead time, the attributes for the print order, and the attributes for the process steps of the print order. The regression model may be used to predict a lead time given an attribute set. The regression model may be further optimized using the test set such that an error rate is minimized. Predictions given by the regression model may be compared to an actual lead time of the test set to evaluate performance of the regression model. An error rate for the regression model may be a root mean square error, a relative squared error, or a mean absolute error.

Probability density function creation instructions 187 may further test the regression model for quality using the test set to yield an error probability density function. A predicted value corresponds to a value predicted by the regression model. An actual value corresponds to the actual time required to complete a process step. A difference between the predicted value and the actual value provides an error value. The error value is divided by the actual lead time to provide a normalized error that is used in the error probability density function. The error value may be further normalized for deriving the error probability density function. Normalization may be carried out by typical statistical normalization procedures, for example, dividing the error value by the actual lead time. The regression model together with the error probability density function may function as the predictive model.

Print job prediction inquiry receiving instructions 126 may receive as user input an inquiry about a completion time of a particular print job, or about individual process steps of the print job. For example, a customer service representative may request a time that a print order is likely to be completed so that he can inform a customer of an estimated completion time. In another example, a foreman may request a time that the print job completes the process steps at resources under his supervision. In a further example, a machine operator may request how many of the print jobs queued at his machine will be completed by a particular time. While FIG. 1 illustrates the print order prediction inquiry as being received at client computing device 100, the print order prediction inquiry may also be received at any of print resources 130, 132, 134. Print job prediction inquiry transmitting instructions 128 may then cause the print job prediction inquiry to be transmitted to server computing device 160 via network 140.

Prediction of completion of print job process step instructions 188 may process the print job prediction inquiry to predict a completion time of the print job, or may predict a completion time of any number of process steps of the print job. After the print production management system is trained by logging the production events and identifying the precedence and resource contention dependencies, the predictive model may be generated using the regression model and the error probability density function. Inputs such as a user inquiry and a current factory workload are used with the predictive model to provide a probabilistic estimate for completing specific process steps of a print job. The current factory work load may be determined from the production event logs 152. The probabilistic estimate may be compared to a confidence threshold to provide final results for completing the specific process steps. For example, a result may be a Boolean value that indicates on-time fulfillment of a potential order, or a list of print jobs that will be finished by a predictive horizon.

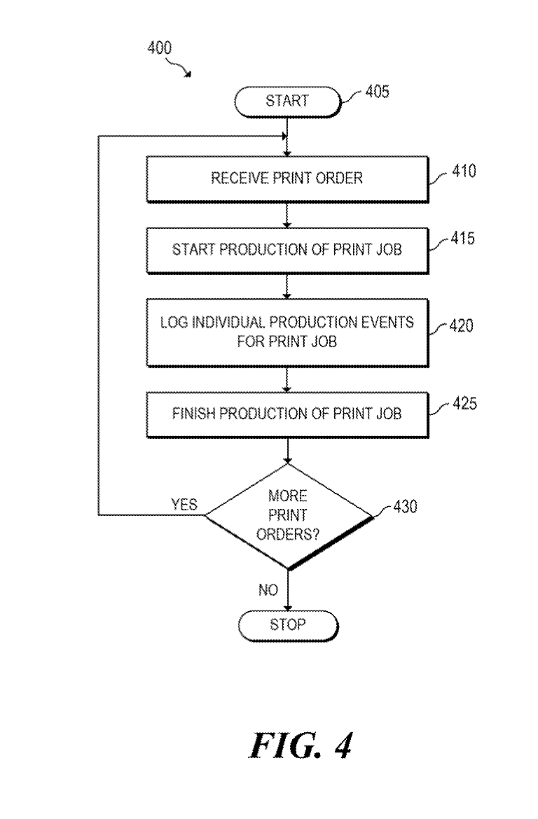

FIG. 4 is a flowchart of an example method 400 for execution by client computing device 100 and server computing device 160 for managing print production. Although execution of method 400 is described below with reference to client computing device 100 and server computing device 160 of FIG. 1, other suitable devices for execution of method 200 will be apparent to those of skill in the art. Method 400 may be implemented in the form of executable instructions stored on a machine-readable storage medium, such as storage mediums 120, 180, and/or in the form of electronic circuitry.

Method 400 may start in block 405 and continue to block 410, where client computing device 100 receives a print order. The print order may be received from a customer by a customer service representative or may be received automatically without human involvement through web-to-print services. The customer service representative may enter the specific attributes of the print order into client computing device 100. For example, the print order may include an identification of quantity, color, and specific finishing processes for the print order that the customer desires.

Next, in block 415, client computing device 100 may transmit the print order to server computing device 160 so that production of a print job to fulfill the print order may begin. Server computing device 160 may be in communication with printing resources 130, 132, 134 where different process steps of the each print job may be executed. For example, server computing device 160 may cause a first process step of print job to be executed at printing resource 130, a second process step of print job to be executed at printing resource 132, and a third process step of print job to be executed at printing resource 134.

In block 420, as the different process steps of the print job are executed, server computing device 160 may cause individual production events corresponding to each process step to be logged in a production event log. The individual production events may include a time at which the print job was ready for the next process step to initiate, a time at which the next process step initiated, a time at which the next process step completed, an identification of the particular printing resource that executed the process step, and an identification of the particular process step that was executed. The production event log may be accessed at a later time to predict a time at which a print job or individual process steps of the print job may be completed. Next, method 400 may continue to block 425 where the print job is completed.

Next, in block 430, a determination is made as to whether additional print orders are received to log additional production events in the production event logs 152 for these orders. When an additional print order is received at client computing device 100, processing returns to block 410 and continues through block 425 as described above such that the production events for the additional print jobs may be recorded in the production event logs 152. This process continues until no additional print orders are received.

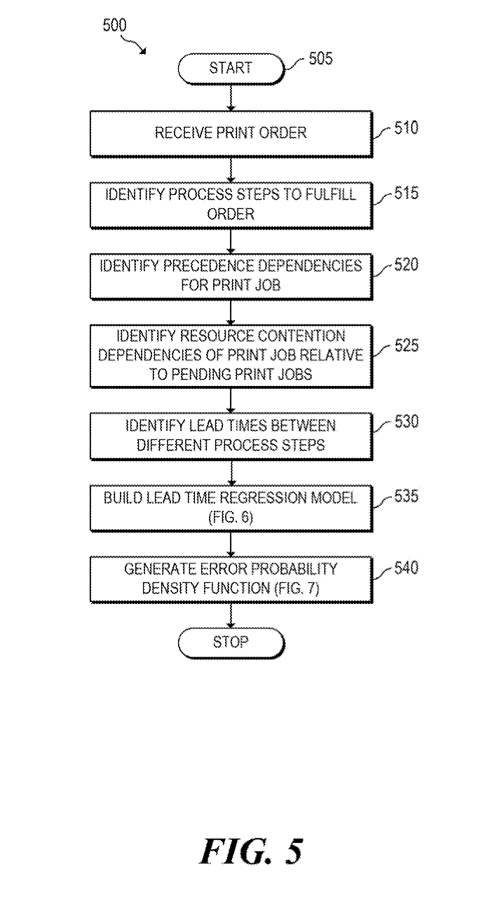

FIG. 5 is a flowchart of an example method 500 for execution by client computing device 100 and server computing device 160 for managing print production. Although execution of method 500 is described below with reference to client computing device 100 and server computing device 160 of FIG. 1, other suitable devices for execution of method 500 will be apparent to those of skill in the art. Method 500 may be implemented in the form of executable instructions stored on a machine-readable storage medium, such as storage medium 120, and/or in the form of electronic circuitry.

Method 500 may start in block 505 and proceed to block 510, where a print order is received at client computing device 100. Client computing device 100 transmits a print job corresponding to the print order to server computing device 160 for execution. As the print job executes, the production events corresponding to process steps of the print job may be recorded in production event logs 152.

Next, in block 515, server computing device 160 identifies the process steps required to complete the print job. Since multiple print jobs are being fulfilled concurrently, execution of the process steps of one print job may interact with execution of the process steps of other print jobs that are also being fulfilled. The execution of a process step may interact with that of other process steps in two ways: precedence dependency and resource contention dependency.

Next, in block 520, server computing device 160 identifies precedence dependencies for the print job. Precedence dependency refers to a process step that cannot be initiated until a different printing process step of the same print job is successfully completed. Process mining techniques are applied on the production event logs 152 to discover the precedence dependencies among different process steps. For each process step that is discovered to have precedence dependencies, the process steps that are to be executed beforehand may be appended as attributes to the process step that is to be performed afterward.

Next, method 500 may continue to block 525 where server computing device 160 identifies resource contention dependencies of the print job relative to other pending print jobs. At any given time and at any machine or work cell, multiple process steps from different print jobs may be awaiting execution at the same resource. For each process step in the resource queue, the higher priority process steps in the same queue are appended as attributes to the lower priority process step. In some implementations, resource contention dependencies may be predicted by mining the production event logs and the order database to discover operational rules that a factory uses to determine a priority among different types of orders. The production event logs and the order database may also be mined to determine which of multiple suitable machines should receive a print job.

Next, in block 530, the lead times between different process steps may be identified by referencing the production event logs, the precedence dependencies and the resource contention dependencies. For example, a process step may be associated with a print job, and another process step may be associated with a different print job. A determination may be made as to when the process step may be completed relative to the other process step by determining a lead time between the two process steps. These determinations are used to construct a training set of lead times. The lead times that are extracted are scope dependent because timestamp differences between process steps may provide lead times at the order level, the product level, the part level and the process step level.

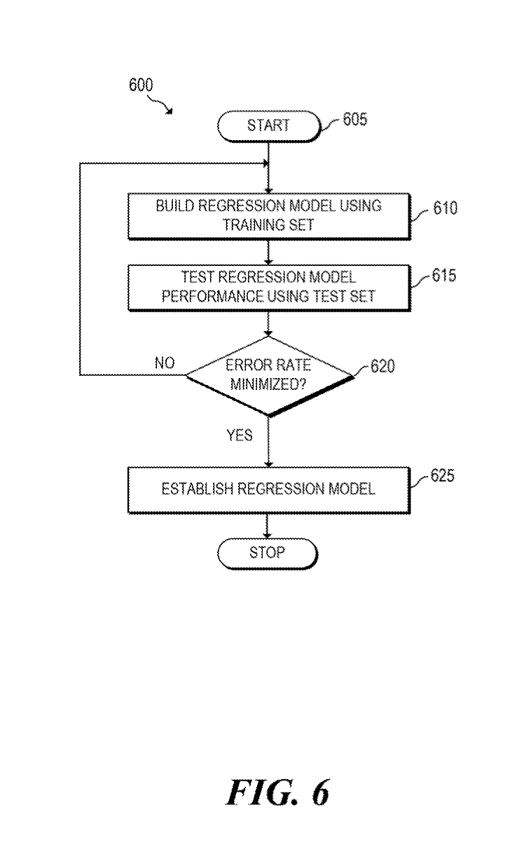

Next, in block 535, a lead time regression model is built based on the training set of scope dependent lead times extracted from the production event logs. The lead time of a print order may be dynamically influenced by different factors. Example factors include order attributes and factory status. Example attributes include a number of book blocks and print quality. Examples of factory status include factory workload, a number of similar orders in the factory, and a queue length of a particular printing resource. The lead time regression model is built and optimized using attributes of different print order instances. Accordingly, when a new print order instance is provided, a lead time for that print order may be predicted by the regression model using the attributes of the print order. The regression model may then be optimized using a test set. The process of building the lead time regression model is described further with reference to FIG. 6.

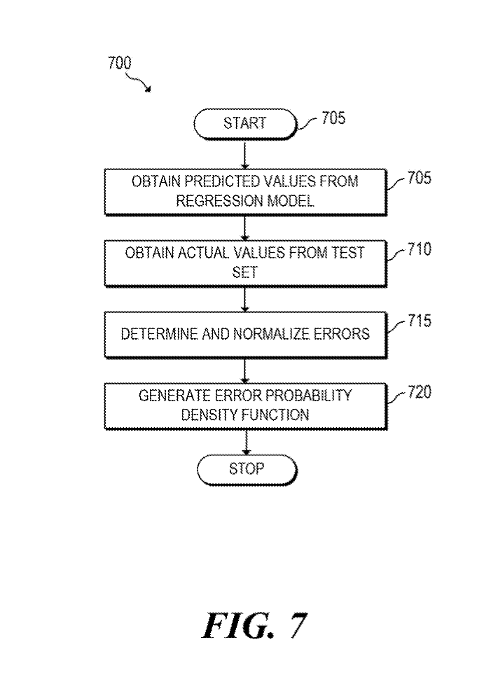

Next, in block 540, an error probability density function is generated using the test set of lead times. The error probability density function compares a predicted time for completing different process steps to an actual time for completing the process steps. The predicted times are accessed from the lead time regression model. A difference between actual times and predicted times provides error values. The error values are then used to create the error probability density function. The process of creating the error probability density function is described further with reference to FIG. 7.

FIG. 6 is a flowchart of an example method 600 for execution by a server computing device 160 for generating a regression model. Although execution of method 600 is described below with reference to server computing device 160 of FIG. 1, other suitable devices for execution of method 600 will be apparent to those of skill in the art. Method 600 may be implemented in the form of executable instructions stored on a machine-readable storage medium, such as storage medium 170, and/or in the form of electronic circuitry.

Method 600 may start in block 605 and proceed to block 610, where a regression model is built at server computing device 160 using a training set of lead times. The training set may include known instances which may include attributes for making a prediction and actual lead times of process steps for print orders. For example, the training set may include the print order, the lead time for the print order, the attributes for process steps of the print order, and a snapshot of the factory's workload at the time.

Next, in block 615, performance of the regression model is tested for optimization using a test set of lead times. The test set may include known instances which may include attributes for making a prediction and actual lead times of process steps of print orders. Predictions given by the regression model may be compared to an actual lead time of the test set to evaluate performance of the regression model. An error rate for the regression model may be a root mean square error, a relative squared error, or a mean absolute error.

Next, in block 620, a determination is made as to whether the error rate is minimized. In the event that the error rate is not minimized, processing returns to block 610 where a new regression model is built and tested. In the event that the error rate is minimized, processing continues to block 625 where the regression model is established. The established regression model may be used to predict a lead time given an attribute set.

FIG. 7 is a flowchart of an example method 700 for execution by a server computing device 160 for generating an error probability density function. The error probability density function compares a predicted time for completing different process steps to an actual time for completing the process steps. Although execution of method 700 is described below with reference to server computing device 160 of FIG. 1, other suitable devices for execution of method 700 will be apparent to those of skill in the art. Method 700 may be implemented in the form of executable instructions stored on a machine-readable storage medium, such as storage medium 170, and/or in the form of electronic circuitry.

Method 700 may start in block 705 and proceed to block 710, where predicted values are obtained from the regression model based on the test set. The predicted values correspond to times at which a process step is predicted to be completed. Next, in block 710, actual values are obtained from the test set of lead times. An actual value corresponds to the actual time required to complete a process step.

Next, in block 715, an error between the actual values and the predicted values is determined and normalized. A difference between the predicted value and the actual value provides the error. The error may be normalized by dividing the error by the actual lead time.

Finally, in block 720, an error probability density function of the normalized errors is generated. The regression model together with the error probability density function may be subsequently used as the predictive model.

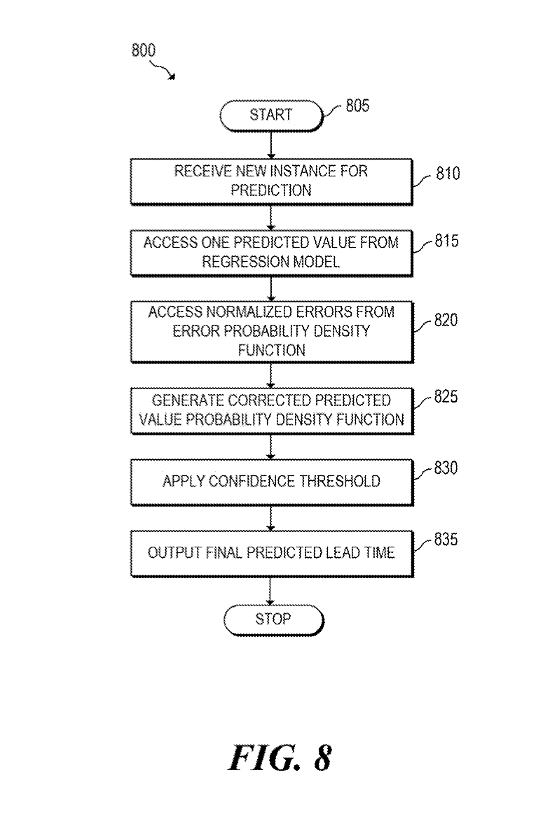

FIG. 8 is a flowchart of an example method 800 for execution by a server computing device 160 for generating an actual value probability density function. Although execution of method 800 is described below with reference to server computing device 160 of FIG. 1, other suitable devices for execution of method 800 will be apparent to those of skill in the art. Method 800 may be implemented in the form of executable instructions stored on a machine-readable storage medium, such as storage medium 170, and/or in the form of electronic circuitry.

Method 800 may start in block 805 and proceed to block 810, where a new instance for prediction is received. The new instance for prediction may be received as a print job prediction inquiry. The prediction inquiry may indicate process steps or a scope of the print job that a user may want to be informed about the time of completion. The prediction inquiry may also include a predictive horizon that indicates a future time at which a status of the print production system is desired. In one implementation, a predictive horizon may be an end of a subsequent shift, and a scope may correspond to a particular production line (e.g., hard cover binding). An example of the predictive inquiry may be by the end of the next shift, provide a list of jobs in the current job queue that will be completed by the hard cover binding production line.

Similar predictions may be made at the order level or any other level of print production. For example, a customer service representative may need to predict if a printing request with a short delivery window is serviceable given the current workload of ending print jobs, and to provide appropriate priority and pricing. In another example, a foreman may need to predict a depletion of a job backlog for his work cell by the end of a shift. In a further example, a pressman may need to predict which printing jobs will be fulfilled before his scheduled break.

Next, in block 815, a predicted value for the new instance is accessed from the regression model. The regression model may be used to predict a lead time given for the new instance. Next, in block 820, normalized errors are accessed from the normalized error probability density function. The predicted value from obtained from the regression model is used to identify a corresponding error from the normalized error probability density function. The normalized error is determined as provided below during the test phase:

normalized error=(predicted value−actual value)/actual value (1)

Thus, the corrected predicted value may be obtained as provided below:

corrected predicted value predicted value/(1+normalized error) (2)

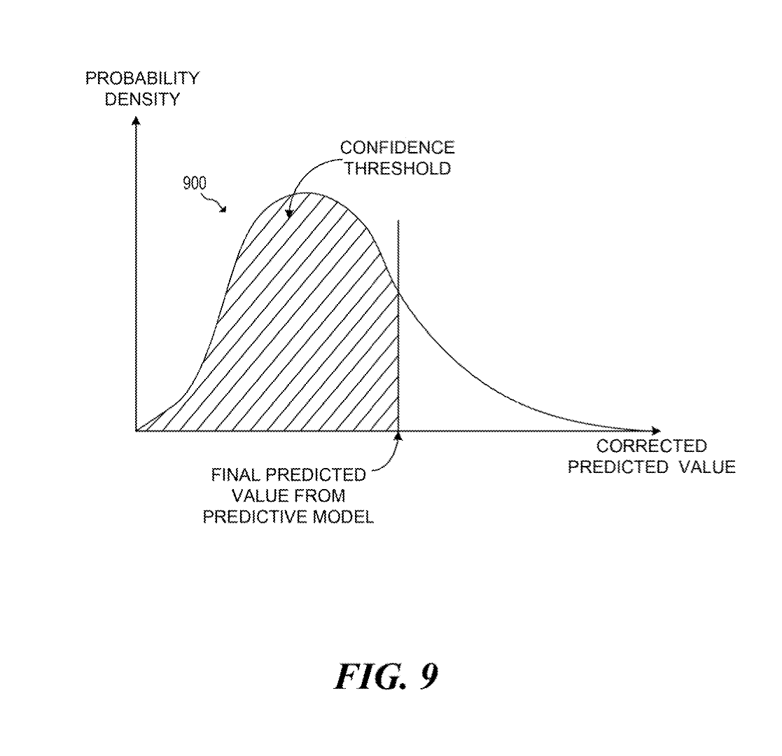

Next, in block 825, the corrected predicted value probability density function is generated. The error probability density function corresponds to the probability density function of normalized errors from previous orders. Accordingly, given one predicted value and the error probability density function, a corrected predicted value may be obtained. Since the corrected predicted value may be obtained from equation (2), the probability density of a corrected predicted value equals the probability density of its corresponding normalized error. Thus, the corrected predicted value probability density function is generated. An example corrected predicted value probability density function 900 is illustrated in FIG. 9.

Next, in block 830, a confidence threshold is applied to the corrected predicted value probability density function. An example confidence threshold is illustrated with reference to the corrected predicted value probability density function of FIG. 9. The confidence threshold may be expressed as a percentage. In some implementations, the confidence threshold may be a value derived from the test set which gives the highest prediction accuracy. In other implementations, the confidence threshold may be a value set by a user, such as by using a control knob. For example, the user may set the confidence threshold at 70% such that if process steps can be predicted as being complete with 75% confidence, then the system indicates that the process steps will be completed on time. If the user sets the confidence threshold to be 95%, then this result does not meet the criteria, and an output is returned that indicates that the process steps will not be completed on time.

When integrating probability density from a smallest corrected predicted value to a particular corrected predicted value, an integrated probability (which may be a value of an integrated area) corresponds to a probability that the final predicted value is no greater than the particular corrected predicted value. The corrected predicted value which may obtain a probability equal to the confidence threshold may be the final predicted value. The final predicted value may correspond to the corrected predicted value for which there are confidence threshold percent predicted values that are not larger than the final predicted value. In other words, based on the performance of the predictive model on historical orders, there is a confidence threshold chance that the real value may be not greater than the final predicted value.

Finally, in block 835, the final predicted lead time is output. In one implementation, the output may be a Boolean value stating whether or not an order is likely to be completed by the predictive horizon. In another implementation, the output may be a list of jobs that are currently pending and that are expected to be completed by the end of the predictive horizon.

As described above, a predictive model may be generated based on a lead time regression model, an error probability density function and a confidence threshold. The predictive model may be used along with a status of pending print jobs and user inputs to predict when different process steps of a print job may be completed.

The foregoing disclosure describes a number of examples for print production management. In this manner, the examples disclosed herein provide real-time forecasting of commercial print production at multiple scopes by discovering factory insights from production event logs.

We claim:

1. A method of managing printing production, the method comprising:
receiving, at a server computing device, an inquiry for a time for completing process steps of a print job;
accessing a production event log from storage, wherein the production event log comprises entries that correspond to different stages of a plurality of pending print orders;
accessing a current status of the pending print orders from the production event log;
generating a predictive model for the print job, wherein the predictive model is generated based on completion times for the process steps of the print job accessed from the production event log;
predicting a time for completing the process steps of the print job based on the predictive model and the current status of the pending print orders; and
preparing for output the predicted time for completing the process steps of the print job.

2. The method of claim 1, further comprising generating the production event log, wherein generating the production event log comprises:
receiving a plurality of print orders; and
logging completion times of individual production events in the plurality of print orders.

3. The method of claim 1, further comprising identifying precedence dependencies for the print job by accessing the production event log, wherein the precedence dependencies indicate a sequence of the process steps for completing the print job, the predictive model being generated based on the precedence dependencies.

4. The method of claim 1, further comprising identifying resource contention dependencies for the print job by accessing the production event log, wherein the resource contention dependencies indicate the print orders that are prioritized over the print job at different stages of the print job, the predictive model being generated based on the resource contention dependencies.

5. The method of claim 1, wherein generating the predictive model comprises:
extracting lead times for the process steps of the print job from the production event log;
building a lead time regression model using the extracted lead times;
generating an error probability density function from the regression model;
generating a corrected predicted value probability density function based on the error probability density function; and
applying a confidence threshold to the corrected predicted value probability density function to obtain the predicted time for completing the process steps of the print job.

6. A machine-readable storage medium encoded with instructions executable by a processor of a server computing device for managing print production, the machine-readable storage medium comprising:
instructions for receiving an inquiry for a time for completing process steps of a print job,
instructions for accessing a production event log from storage, wherein the production event log comprises entries that correspond to different stages of a plurality of pending print orders,
instructions for extracting lead times for the process steps of the print job from the production event log,
instructions for budding a lead time regression model using the extracted lead times,
instructions for creating an error probability density function from the regression model,
instructions for generating a predictive model using the lead time regression model and the error probability density function, and
instructions for predicting a time for completing the process steps of the print job based on the lead time regression model, the error probability density function and a current status of the pending print orders, wherein the current status of the pending print orders is determined from the production event log.

7. The machine-readable storage medium of claim 6, further comprising instructions for generating the production event log, wherein the instructions for generating the production event log comprise:
instructions for receiving a plurality of print orders; and
instructions for logging completion times of individual production events in the plurality of print orders.

8. The machine-readable storage medium of claim 6, further comprising instructions for identifying precedence dependencies for the print job, wherein the precedence dependencies indicate a sequence of the process steps for completing the print job, the predictive model being generated based on the precedence dependencies.

9. The machine-readable storage medium of claim 6, further comprising instructions for identifying resource contention dependencies for the print job, wherein the resource contention dependencies indicate the print orders that are prioritized over the print job at different stages of the print job, the predictive model being generated based on the resource contention dependencies.

10. The machine-readable storage medium of claim 6, wherein the instructions for predicting a time for completing the process steps of the print job comprise:
generating a corrected predicted value probability density function based on the error probability density function; and
applying a confidence threshold to the corrected predicted value probability density function to obtain the predicted time for completing the process steps of the print job.

11. A server computing device for processing data, the server computing device comprising:
a processor to:
receive an inquiry for a time for completing process steps of a print job;
access a production event log from storage, wherein the production event log comprises entries that correspond to different stages of a plurality of pending print orders;
generate a predictive model for the print job, wherein the predictive model is generated based on completion times for the process steps of the print job accessed from the production event log; and
generate a predicted time for completing the process steps of the print job based on the predictive model and a current status of the pending print orders, wherein the current status of the pending print orders is determined based on the production event log.

12. The server computing device of claim 11, wherein the processor further acts to generate the production event log by:
receiving a plurality of print orders; and
logging completion times of individual production events in the plurality of print order.

13. The server computing device of claim 11, wherein the processor further acts to:
identify precedence dependencies for the print job, wherein the precedence dependencies indicate a sequence of the process steps for completing the print job, the predictive model being generated based on the precedence dependencies.

14. The server computing device of claim 11, wherein the processor further acts to:
identify resource contention dependencies for the print job, wherein the resource contention dependencies indicate the print orders that are prioritized over the print job at different stages of the print job, the lead, time predictive model being generated based on the resource contention dependencies.

15. The server computing device of claim 11, wherein the processor generates the predictive model by:
extracting lead times for the process steps of the print job from the production event log;
building a lead time regression model using the extracted lead times;
generating an error probability density function from the regression model;
generating a corrected predicted value probability density function based on the error probability density function; and
applying a confidence threshold to the corrected predicted value probability density function to obtain the predicted time for completing the process steps of the print job.
